(19) United States
(12) Patent Application Publication
(10) Pub. No.: US 2004/0030686 A1
(43) Pub. Date: Feb. 12, 2004

(54) Method and system of searching a database of records

(76) Inventors: Andrew John Cardno, Wellington (NZ); Nicholas John Mulgan, Wellington (NZ)

Correspondence Address: David E. Bruhn, DORSEY & WHITNEY LLP, Intellectual Property Department, 50 South Sixth Street, Suite 1500, Minneapolis, MN, 55402-1498, US

(21) Appl. No.: 10/456,960

(22) Filed: Jun. 6, 2003

Related U.S. Application Data
(63) Continuation of application No. PCT/NZ01/00273, filed on Dec. 7, 2001.

(30) Foreign Application Priority Data
Dec. 7, 2000 (NZ) 508695

(51) Int. Cl. G06F 7/00

(52) U.S. Cl. 707/3

(57) ABSTRACT

The invention provides an electronic document indexing system comprising a memory in which is stored one or more index entries, each index entry comprising a unique keyword and one or more data items, one or more of the data items representing the address of an electronic document accessible over a network; a query component configured to parse a user query into terms and operators relating the terms; a search engine configured to retrieve one or more index entries satisfying the query from the memory; a retrieval component configured to extract one or more electronic document addresses from the retrieved index entry or entries and to retrieve the electronic document(s) over the network; and a display configured to present the retrieved electronic documents to a user. The invention further provides a related electronic document index and a method of indexing electronic documents.

### CROSS-REFERENCE TO RELATED APPLICATION(S)

This application is a continuation of International Application Number PCT/NZ01/00273, filed on Dec. 7, 2001, which claims priority of New Zealand Application Number 508695, filed on Dec. 7, 2000, the contents of both are incorporated herein by reference. The international application was published under PCT Article 21(2) in English.

### FIELD OF INVENTION

The invention relates to a method and system of searching a database of records and in particular the invention relates to an electronic document indexing system and method and an electronic document index. The invention is particularly suited for use in conjunction with an Internet search engine for locating web pages of interest to a user.

### BACKGROUND TO INVENTION

The low cost of data storage hardware has led to the collection of large volumes of data. The worldwide web, for example, is a distributed database providing access to tens of millions of different documents. Users of such networks generally need to locate specific web pages or other electronic documents containing information of interest and it is vital that these pages be located and retrieved within a reasonable time frame. Each user generally has a choice of one or more search engines with which to locate relevant documents.

U.S. Pat. No. 5,864,863 to Burrows for example describes a system for indexing and searching databases. The system stores a series of word location pairs in a database. One difficulty with such a system is that common words may appear at hundreds of millions of different locations. The Burrows specification describes the use of compressing techniques to decrease the amount of storage and also describes the use of summarising techniques to reduce processing requirements while searching.

U.S. Pat. No. 5,696,963 to Ahn describes a search engine having a group index table. Each entry in the table includes an indexed word, a document field including the document or web page on which the word appears, and a location in the document field indicating the location of the word in the document.

The systems described in the Burrows and Ahn patent specifications have disadvantages. For example, as each word entry consists of a word stored as one or more bytes and a series of location entries, it is necessary to store and retrieve large amounts of data. Various compression techniques are needed to save space which can reduce the speed of retrieving data from these databases.

### SUMMARY OF INVENTION

In broad terms in one form, the invention comprises an electronic document indexing system comprising one or more index entries maintained in computer memory, at least one index entry indexed by a unique keyword and comprising one or more data items, one or more of the data items representing the address of an electronic document accessible over a network; a query component configured to parse a user query into terms and operators relating the terms; a search engine configured to retrieve one or more index entries satisfying the query from computer memory; a retrieval component configured to extract one or more electronic document addresses from the retrieved index entry or entries and to retrieve the electronic document(s) over the network; and a display configured to present the retrieved electronic documents to a user.

In broad terms in another form, the invention comprises an electronic document index comprising one or more index entries maintained in computer memory, at least one index entry indexed by a unique keyword and comprising one or more data items representing the address of an electronic document accessible over a network.

In broad terms in a further form the invention comprises a method of indexing electronic documents comprising the steps of maintaining in computer memory one or more index entries, at least one index entry indexed by a unique keyword and comprising one or more data items, one or more of the data items representing the address of an electronic document accessible over a network; parsing a user query into terms and operators relating the terms; retrieving one or more index entries satisfying the query from computer memory; extracting one or more electronic document addresses from the retrieved index entry or entries; retrieving the electronic documents over the network; and presenting the retrieved electronic documents to a user.

### BRIEF DESCRIPTION OF THE FIGURES

Preferred forms of the electronic indexing system and method will now be described with reference to the accompanying Figures in which:

FIG. 1 shows a block diagram of a system in which one form of the invention may be implemented;

FIG. 2 shows the preferred system architecture of hardware on which the present invention may be implemented;

FIG. 3 is a conceptual view of one form of the index of the invention;

FIG. 4 is one preferred implementation of the index of FIG. 3; and

FIG. 5 is a flowchart of a preferred form of the invention.

### DETAILED DESCRIPTION OF PREFERRED FORMS

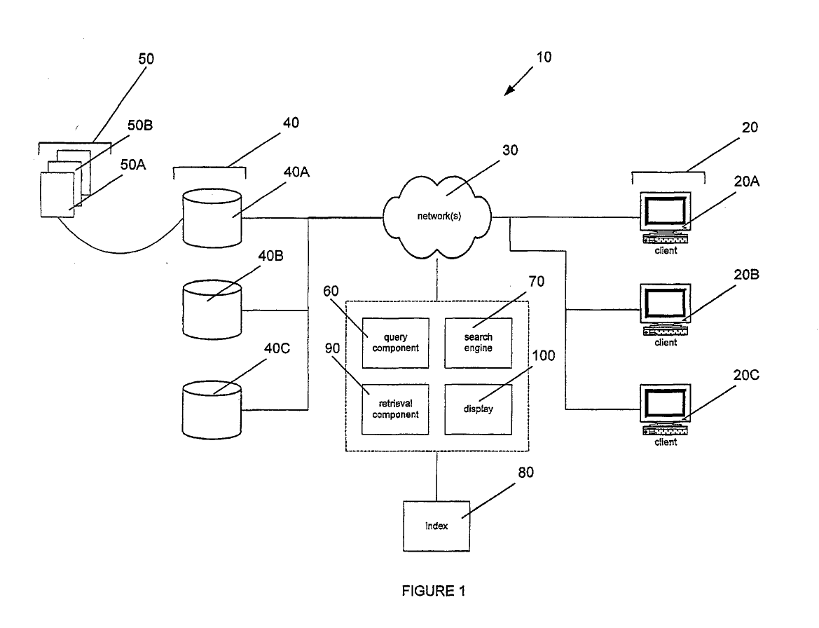

FIG. 1 illustrates a block diagram of the preferred system 10 in which one form of the present invention may be implemented. The system includes one or more clients 20, for example 20A, 20B and 20C, which each may comprise a personal computer or workstation described below. Each client 20 is connected to a network 30 as shown. It is envisaged that network 30 could comprise a local area network or LAN, a wide area network or WAN, an Internet, Intranet or wireless access network.

System 10 further comprises one or more servers for example 40A, 40B and 40C. Each server 40 is connected to network or networks 30 as shown in FIG. 1. Each server 40 could comprise a personal computer, workstation or other computing device but may also comprise several workstations connected by separate private networks.

The system 10 further comprises electronic documents 50 for example 50A, 50B and 50C maintained on a server 40. Each electronic document 50 could comprise a web page comprising textual information, multimedia content, software programs, graphics, audio signals, videos and so on. Each document 50 preferably includes a unique network address, by which the document is indexed.

A user on client 20 in general transmits a document request over the network(s) 30. The network(s) 30 and servers 40 route the request to the most appropriate server 40 on which the required document 50 is stored. The document request preferably specifies the network address of that document. If the document is located, the document is retrieved from the appropriate server 40 and transmitted over the network(s) 30 to the user on client 20. If the document 50 cannot be found, or cannot be found within a pre-specified “time out” period, an error message is displayed to the user 20 instead of the document.

In many cases, the user does not know the exact network address of the requested document. In these circumstances, the user may make use of a search engine. The user specifies a set of characteristics, called a query, which characterise a particular document to the best of the user's knowledge. This query is sent to a query component 60 which is arranged to process or parse the query into a set of individual components. The parsed query is then passed to search engine 70. The search engine 70 checks one or more document indexes shown at 80. Index entries matching the search criteria are extracted from the index. Each index entry generally specifies one or more electronic documents and the respective network addresses of those documents. A retrieval component 90 extracts document addresses from the index entries and transmits document requests over the network(s) 30 to retrieve or fetch the relevant electronic document or documents 50 from the appropriate server 40. A display component 100 then formats the document(s) in order to display the results of the query and/or individual documents located to a user on client 20.

It will be appreciated that the individual query component 60, the search engine 70, the index 80, the retrieval component 90 and the display 100 could all be implemented on a client workstation 20 or could be implemented on a separate workstation interfaced to network(s) 30. It will also be appreciated that any one or more of these components could be implemented separately from each other and interfaced to network(s) 30.

The invention provides an index 80 to more efficiently and effectively retrieve documents 50 from a server 40 over network(s) 30 at the request of a user on client 20.

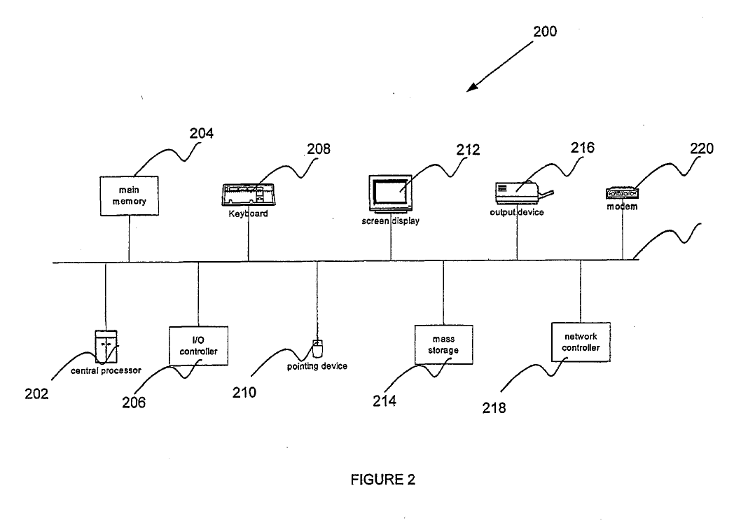

FIG. 2 shows the preferred system architecture of a client 20 or server 40. The computer system 200 typically comprises a central processor 202, a main memory 204 for example RAM and an input/output controller 206. The computer system 200 also comprises peripherals such as a keyboard 208, a pointing device 210 for example a mouse, trackball or touch pad, a display or screen device 212, a mass storage memory for example a hard disk, floppy disk or optical disc, and an output device 216 for example a printer. The computer system 200 could also include a network interface card or controller 218 and/or a modem 220. The individual components of the system 200 could communicate through a system bus 222 or could be implemented as individual components in a network.

It is envisaged that known equivalents could be substituted for the components of the computer system 200 described above. For example, the keyboard 208 is one form of data entry device which could be replaced or supplemented with other data entry devices, for example a touch sensitive screen or voice activated speech recognition hardware and software.

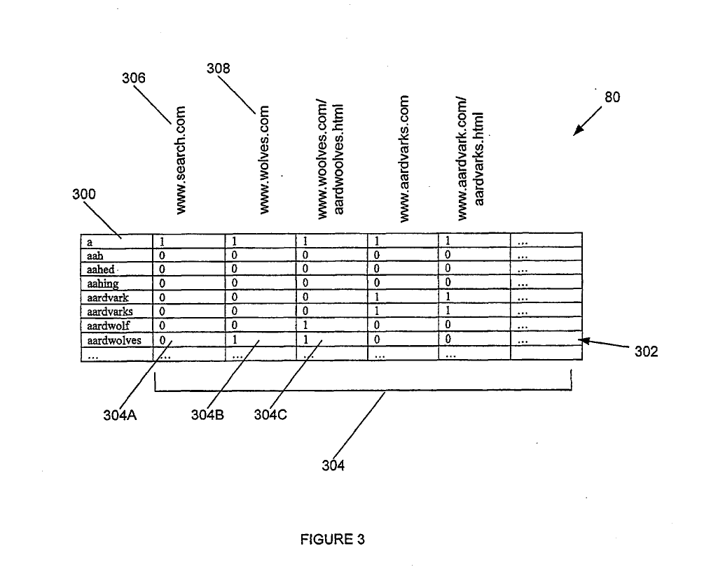

FIG. 3 shows a conceptual view of a preferred index 80 in accordance with the invention. The preferred index 80 includes a series of unique search terms or keywords as shown at 300. The search terms could include individual English words and could also include word combinations and phrases. The keywords 300 could further comprise letter, number and/or character combinations which are not recognised English words and could also further comprise non-English words. As shown in FIG. 3, the list of search terms are preferably ordered alphabetically.

Each row of the table shown in FIG. 3 comprises an index entry, each index entry indexed by a different keyword. One such index entry is shown at 302. It will be appreciated that implementation of the table could include indexing such as B-tree indexing or other equivalent techniques to speed up search queries. Each index entry further comprises a series of data items 304, for example 304A, 304B and 304C. At least one and preferably each data item comprises one of two data values and in a preferred form each data item could either be a null data value or a non-null data value. Each data item may comprise for example a binary number or boolean flag for example as shown in FIG. 3 in which each data item has the value of 0 or 1.

At least one data item and preferably each data item represents and corresponds to a unique electronic document address, for example a URL. As shown in FIG. 3, data item 304A corresponds to the URL www.search.com 306 and 304B corresponds to www.wolves.com. In the example table, the keyword “aardwolves” does not appear in the electronic document at www.search.com as data item 304A shows a null value in the index entry for “aardwolves”. However, data item 304B shows a non-null value, 304B, in the column corresponding to www.wolves.com, which indicates that the keyword “aardwolves” appears in the electronic document at www.wolves.com.

The preferred form index does not store the location of each word in the relevant electronic document, as is the case with the prior art indexing techniques described in U.S. Pat. Nos. 5,864,863 to Burrows and 5,696,963 to Ahn. The index simply stores data on the presence or absence of a particular word in a particular document.

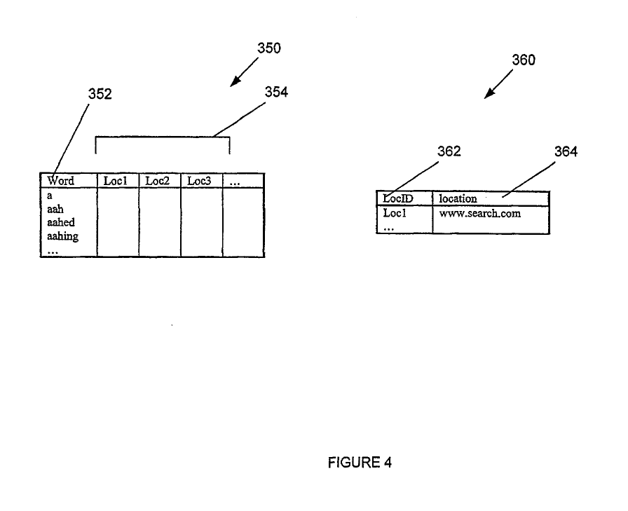

FIG. 4 shows one possible implementation of the document index of FIG. 3 in a relational database. The database schema preferably comprises a word table 350 and a location table 360. The word table 350 comprises one field forming the primary key 352 which contains the word to be searched. The schema preferably also further comprises a series of further fields 354 which are each arranged to store a boolean value. Each data record will therefore comprise a unique word forming a primary key and a string or sequence of boolean data values.

These data values are preferably linked to address data values stored in table 360 as shown. Table 360 preferably comprises a location identifier 362 as a field and a text string field 364 storing the actual network location. In one form the invention may recognise a particular boolean data value from table 350 as corresponding to a network address in table 360 by the order in which that boolean value appears in the sequence of data values in table 350.

In another preferred form, the data items in the index 350 could comprise a null value where a particular word does not appear in an electronic document. Where a word does appear in an electronic document, the data value could comprise a pointer to the appropriate network address.

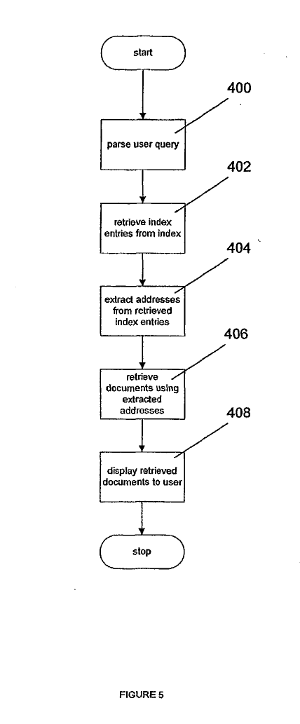

FIG. 5 shows a preferred method of operation of the invention. A user on client 20 transmits a query to query component 60. Individual queries could include one or more search words for example “aardvark”. The query could also include one or more logical or boolean operators, for example “and”, “or” or “not”. A typical search could be AARDVARK NOT AARDWOLVES which would return all documents which contain the word “aardvark” but not the word “aardwolves”. The query could also include wildcard characters, for example an “*” specifying 0 or more alpha-numeric characters and “?” specifying one alpha-numeric character. For example, the query AARDVARK* would locate all words with the prefix “aardvark-”.

The user query is parsed as indicated at 400 into search words and logical operators. Each search word in the query is then checked against the keywords in the index 80, taking into account logical operators and wildcards specified in the query.

Index entries in which the keywords match the user queries are retrieved from the index as shown at 402. The retrieved index entry or entries will generally comprise a series of keywords located in the search with a sequence of boolean data values for each keyword. Those data values which are non-null are linked to address data values and the address data values are then extracted as indicated at 404.

The set of retrieved and extracted address data values are then sent over network(s) 30 by retrieval component 90 in the form of electronic document requests as indicated at 406. The requested electronic documents 50 are then fetched from the appropriate server 40 and transmitted over the network(s) 30.

As shown at 408, the electronic documents are displayed to a user. It will be appreciated that the display could either display the entire document to the user or the display could alternatively display a summary of each document where there are many documents. The user could then elect which documents to retrieve from the relevant servers.

The index described above provides an improved technique for accessing electronic documents over a network. The advantage of storing boolean data values in a table is that searching those data values can be performed very quickly. The fact that locations of words within documents are not stored within the index reduces the storage space required for index and furthermore speeds up processing of such search requests.

The index described above can also be updated easily, for example by sending out a robot or other automated search engine to retrieve batches of electronic documents and to parse those electronic documents into keywords, adding individual keywords and other words into the index.

A further advantage of the index of the invention is that the field of each search can be restricted. By controlling the number and nature of electronic documents in the index, a user, or a system administrator can control how broad a user may search for electronic documents. This will be useful for example when an organisation wishes to restrict searching capabilities to those electronic documents within a particular organisation, for example in an Intranet arrangement, or when a user wishes to focus on a particular category of documents.

The foregoing describes the invention including preferred forms thereof. Alterations and modifications as will be obvious to those skilled in the art are intended to be incorporated within the scope hereof, as defined by the accompanying claims.

1. An electronic document indexing system comprising:
one or more index entries maintained in computer memory, at least one index entry indexed by a unique keyword and comprising one or more data items, one or more of the data items representing the address of an electronic document accessible over a network;
a query component configured to parse a user query into terms and operators relating the terms;
a search engine configured to retrieve one or more index entries satisfying the query from computer memory;
a retrieval component configured to extract one or more electronic document addresses from the retrieved index entry or entries and to retrieve the electronic document(s) over the network; and
a display configured to present the retrieved electronic documents to a user.

2. An electronic document indexing system as claimed in claim 1 wherein one or more of the data items comprises one of two data values.

3. An electronic document indexing system as claimed in claim 2 wherein at least one of the data items comprising one of two data values comprise either a null or a non-null data value.

4. An electronic document indexing system as claimed in claim 3 wherein those data items having non-null data values correspond to respective addresses of electronic documents accessible over a network.

5. An electronic document indexing system as claimed in claim 1 wherein the search engine is configured to retrieve one or more index entries from computer memory, at least one of the retrieved index entries comprising a sequence of data items, at least one data item having either a null or a non-null data value.

6. An electronic document indexing system as claimed in claim 1 further comprising one or more address data items maintained in computer memory, at least one address data item representing the address of an electronic document accessible over a network.

7. An electronic document indexing system as claimed in claim 6 wherein the address data items are stored in computer memory as a sequence.

8. An electronic document indexing system as claimed in claim 7 wherein the sequence of data items of the index entry correspond to the sequence of address data items.

9. An electronic document index comprising one or more index entries maintained in computer memory, at least one index entry indexed by a unique keyword and comprising one or more data items representing the address of an electronic document accessible over a network.

10. An electronic document index as claimed in claim 9 wherein one or more of the data items comprise one of two data values.

11. An electronic document index as claimed in claim 10 wherein those data items which comprise one of two data values comprise either a null or a non-null data value.

12. An electronic document index as claimed in claim 11 wherein those data items having non-null data values correspond to respective addresses of electronic documents accessible over a network.

13. A method of indexing electronic documents comprising the steps of:
maintaining in computer memory one or more index entries, at least one index entry indexed by a unique keyword and comprising one or more data items, one or more of the data items representing the address of an electronic document accessible over a network;
parsing a user query into terms and operators relating the terms;
retrieving one or more index entries satisfying the query from computer memory;
extracting one or more electronic document addresses from the retrieved index entry or entries;
retrieving the electronic documents over the network; and
presenting the retrieved electronic documents to a user.

14. A method of indexing electronic documents as claimed in claim 13 wherein one or more of the data items comprise one of two data values.

15. A method of indexing electronic documents as claimed in claim 14 wherein those data items which comprise one of two data values comprise either a null or a non-null data value.

16. A method of indexing electronic documents as claimed in claim 15 wherein those data items having non-null data values correspond to respective addresses of electronic documents accessible over a network.

17. A method of indexing electronic documents as claimed in claim 13 further comprising the step of retrieving one or more index entries from computer memory, at least one of the retrieved index entries comprising a sequence of data items, at least one data item having either a null or a non-null data value.

18. A method of indexing electronic documents as claimed in claim 13 further comprising the step of maintaining in computer memory one or more address data items, at least one address data item representing the address of an electronic document accessible over a network.

19. A method of indexing electronic documents as claimed in claim 18 wherein the address data items are stored in computer memory as a sequence.

20. A method of indexing electronic documents as claimed in claim 19 wherein the sequence of data items of the index entry correspond to the sequence of address data items.
